(19) United States
(12) Patent Application Publication
(10) Pub. No.: US 2014/0251396 A1
(43) Pub. Date: Sep. 11, 2014

(54) Venucane: An Electronic Travel Aid for Visually Impaired and Blind People

(71) Applicant: Indian Institute of Technology, Kharagpur, West Bengal, Kharagpur (IN)

(72) Inventors: Bhatlawande Shripad Subhashrao, West Bengal (IN); Manjunatha Mahadevappa, West Bengal (IN); Jayant Mukhopadhyay, West Bengal (IN)

(73) Assignee: Indian Institute Of Technology of Kharagpur, West Bengal, Kharagpur (IN)

(21) Appl. No.: 14/348,175

(22) PCT Filed: Sep. 28, 2012
(86) PCT No.: PCT/IN2012/000654

§ 371 Date: Mar. 28, 2014

(30) Foreign Application Priority Data
Sep. 30, 2011 (IN) 1288/KOL/2011

(51) Int. Cl. A45B 3/00; G01V 11/00

(52) U.S. Cl. CPC A45B 3/00; G01V 11/00
USPC 135/66

(57) ABSTRACT

An electronic travel aid (ETA) for visually impaired and blind people (subject) with minimum physical interface adapted to perform real-time navigation without digital camera and complex hardware. Importantly, the electronic travel aid relates to real-time situations with speech messages stored in flash memory for aiding the visually impaired or blind people. The electronic travel aid is provided involving wireless or wired technology and is directed to serve as a low-cost, robust, reliable, and user-friendly solution for blind or visually impaired navigation.

### FIELD OF INVENTION

The present invention relates to an electronic travel aid (ETA) for visually impaired and blind people (subject). Advantageously, the electronic travel aid of the invention has been developed with minimum physical interface and is adapted to perform real-time navigation without digital camera and complex hardware. Importantly also the electronic travel aid relates to real-time situations with speech messages stored in flash memory for aiding the visually impaired/blind people. The electronic travel aid can be provided involving wireless or wired technology and is directed to serve as a low-cost, robust, reliable and user-friendly solution for blind/visually impaired navigation.

### BACKGROUND ART

As per 2009 survey conducted by World Health Organization (WHO), there are 314 million visually impaired and 45 million blind people world-wide. Certainly reliable and affordable solution for providing mobility aid to the visually impaired has significant social and commercial interest for government, laboratories and industry.

Existing electronic travel aids (ETAs) are inclined to use computer vision based navigation with stereo digital cameras and multiple sensors, like ultrasonic, optical, LASER, sonar etc. Inventors have used Global Positioning System (GPS), Radio Frequency identification, Bar-code technology in blind navigation.

Existing high end systems are promising, but are much bulkier, costlier, have maximum physical interface and require long training.

Although there are several obstacle detector/surveillance systems and/or electronic travel/mobility aid system available in the market to assist the visually impaired there is a need in the art to develop such systems that on hand would be economical and hence would be affordable and on the other hand will be simple involving minimum physical interface and would be able to perform real-time navigation without the involvement of digital camera and complex hardware and yet relate to real-time situations with possible speech alerts and also including safety indicators for detecting smoke, liquid and metal favoring wide scale acceptance as an aid to the visually impaired/blind people.

### OBJECTS OF THE INVENTION

Thus the primary object of the present invention is to provide for electronic travel aid (ETA) for Visually impaired and blind people with minimum physical interface for real time navigation of real-time situations which would enable detection of object/obstacle from ground level height to head level height in front, left and right direction.

Another object of the present invention is directed to provide for electronic travel aid (ETA) for visually impaired and blind people with minimum physical interface for real time navigation of real-time situations which would enable detection of staircase and assistance for up stair & down stairs with better and safe indication system.

Another object of the present invention is to provide for electronic travel aid (ETA) for visually impaired and blind people with minimum physical interface for real time navigation of real-time situations comprising safety indicators for the detection of smoke, liquid and metal and including means for conveying the said detected condition to the subject through speech based announcement means incorporated in the said system.

Yet another object of the present invention is to provide for electronic travel aid (ETA) for visually impaired and blind people with minimum physical interface for real time navigation of real-time situations that would enable detection of non-formal/formal obstacles distance scaling for detected obstacles including provision of speech based announcement.

A further object of the present invention is directed to providing for electronic travel aid (ETA) for visually impaired and blind people with minimum physical interface for real time navigation of real-time situations which would have the desired flexibility of any language for speech warning messages thereby further benefiting the visually challenged persons from every walk of life.

Yet another object of the present invention is directed to provide for electronic travel aid (ETA) for visually impaired and blind people with minimum physical interface for real time navigation of real-time situations which could be adapted to favor both wired or wireless communication with the subject.

Another object of the present invention is to provide for electronic travel aid (ETA) for visually impaired and blind people with minimum physical interface for real time navigation of real-time, situations that would be reliable, cost-effective and consume less power in being light weight, portable and strong to resist weathering, and which would also require less training time to be a user-friendly solution for blind navigation.

### SUMMARY OF THE INVENTION

The basic aspect of the present invention is thus directed to an electronic travel aid enabling real-time navigation for visually impaired and blind people comprising:

a walking stick like implement/cane comprising selectively disposed object/obstacle detection sensor means and safety indicating sensors selected from anyone or more of smoke detection sensor, liquid detection sensors, metal detection sensor; microcontroller and transceiver means adapted to receive the sensor inputs and generating outputs for assisting the visually impaired and blind people; and operative power source.

A further aspect of the present invention is directed to an electronic travel aid comprising:

transmitter part embedded in said walking stick like implement/cane preferably having a grip means at the front including (a) ground level to waist level object/obstacle detection sensor means comprising eight ultrasonic sensors mounted within comprising of four ultrasonic sensors mounted on front side, two sensors on back side, one sensor on left side and one sensor on right side and (b) said safety indicating sensors comprising embedded ultrasonic sensor pairs including smoke/fire detection sensor, liquid detection sensor and metal detection sensor (c) said microcontroller and wireless transceiver means;

operatively connected receiver part comprising wireless transceiver, microcontroller and audio means adapted to generate audio outputs preferably selected from buzzer, pre-recorded messages/speeches, audio recording and playback flash memory for generating outputs for assisting the visually impaired and blind people; and

operative power source including preferably operable at single positive 9V DC power supply.

A still further aspect of the present invention is directed to an electronic travel aid wherein the disposition of the said four ultrasonic sensors mounted on front side, two sensors on back side, one sensor on left side and one sensor on right side and (b) said safety indicating sensors comprising embedded ultrasonic sensor pairs including smoke/fire detection sensor, liquid detection sensor and metal detection sensor are selectively provided based on the height of the travel aid keeping in view the height/comfort of the visually impaired and blind person.

A still further aspect of the present invention is directed to an electronic travel aid comprising means for data collection and processing (DCPS) involving (i) DCPS vision section comprising a network of said ultrasonic sensor pairs adapted for object/obstacle detection from ground level to waist level height of the subject in front, left and right side including staircase detection, up stair and down stair application (ii) DCPS safety section comprising said network of smoke, liquid and metal detection sensors adapted to avoid life threatening injuries by conveying to the subject the presence of smoke, fire, gas, presence of liquid/water spillage on the floor and also the presence of metallic fencing, metallic casing, metallic floor and (iii) DCPS decision and control section comprising an 8-bit microcontroller adapted for processing real-time data collected by the sensors placed in said vision and safety sections thus enabling real-time navigation performed with scaled obstacle distance warning and effective usage of interrupts of adapted to invoke the stored pre-recorded speech messages based on the real-time detected and understood situations through repeated sampling of data before communicating a decision; and means for speech/audio announcement section (SAS) including speech announcement which are operatively connected through wireless/wired modes with language flexibility for conveying detected conditions to the subject preferably involving audio recording and playback flash memory with capacity to store speech messages with desired duration with a specific control on the number of messages that may be increased by reducing the duration of each message also involving universal language to record speech warning messages to thereby invoke a relevant message from flash memory to be conveyed to the subject through a headphone/ear phone for the purpose of alerting the subject on the detected obstacle/situation.

A still further aspect of the present invention is directed to an electronic travel aid wherein the wireless mode of connectivity is through half duplex wireless communication including a radio frequency modem preferably 2.4 GHz operated Radio Frequency (RF) modem and a baud rate 9600 bits per second (bps) communication and said wired mode of communication includes detachable connector between DCPS and SAS.

A still further aspect of the present invention is directed to an electronic travel aid wherein front four sensors adapted for detection of ground level to waist level object/obstacle in front direction with the lower three ultrasonic sensors in front direction enable detection of up staircase, the Left and right sensors are adapted for detection of left and right side object/obstacle and two ultrasonic sensors are mounted on lower back-side are exclusively used for detection of down staircase.

A still further aspect of the present invention is directed to an electronic travel aid wherein the said lower three ultrasonic sensors in front direction enable detection of up staircase, an interrelated structured pattern of distance variation detected by these three sensors is involved for detection of staircase with repeated sampling of data for concluding staircase detection and subject can up stair and can understand the end of staircase with the help of stored speech messages and wherein the two ultrasonic sensors mounted on lower back-side of said cane are exclusively used for detection of down staircase and the subject can down stair and can understand the end of staircase with the help of stored speech messages.

A still further aspect of the present invention is directed to an electronic travel aid wherein said sensor means for the detection of staircase comprise first front lower sensor (s₁), second front lower sensor (s₂), third front lower sensor (s₃), Front upper sensor (s₄), first rear lower sensor (s₅), second rear lower sensor (s₆), left side sensor (s₇) and right side sensor (s₈) and said microcontroller and transceiver means is adapted to detect staircase based on said sensor inputs based on:
d(x) distance detected by a sensor (cm)
x tread depth (cm)
e error between theoretical and actual reading; and
   riser height and tread depth and generating therefrom:
(i) Average distance readings d(s₁), d(s₂), d(s₃), d(s₄) d(s₅) and d(s₆) obtained from sensor cycles ψ(i) and ψ(i+1)
(ii) Verifying:

d(s₄)≅d(s₃)+x+e (1)

d(s₃)≅d(s₂)+x+e (2)

d(s₂)≅d(s₁)+x+e (3)
(iii) Correlating between d(s₁), d(s₅) and d(s₆)
(iii) Computing distance values for x and error value e
(iv) Computing a pattern based on detected distances values
(v) If pattern indicates presence of up or down staircase, announcing it through speech message means and guiding the subject involving means preferably buzzer beep to proceed on the staircase.

A still further aspect of the present invention is directed to an electronic travel aid which is adapted to calculate dynamic distance of the object/obstacle from subject involving ultrasonic sensor and microcontroller means and also the floor status including dry, wet, metallic, non-metallic as well as generate safety indications on detection of smoke/fire.

Yet another aspect of the present invention is directed to an electronic travel aid comprising two liquid detection sensors and one metal detection sensor wherein two probes of the first liquid detection sensor are mounted spaced apart on the bottom periphery of the said walking implement/cane and the said metal detection sensor is mounted inside at about 2 cm height from ground, two probes of the second liquid detection sensor are insulated and mounted above metal detection sensor such as to distinguish between metal and liquid based on the following:

| | Output of | | | |
|---|---|---|---|---|
| | first | | | Discrimination of |
| | liquid | Output of metal | Output of second | liquid and metal |
| Sr. | detection | detection | liquid detection | based on sensor |
| No. | sensor | sensor | sensor | outputs |
| 1 | NO | NO | NA* | None |
| 2 | NO | Yes | NA* | Metal |
| 3 | Yes | NO | NA* | Liquid |
| 4 | Yes | Yes | No | Metal |
| 5 | Yes | Yes | Yes | Both liquid and |
| | | | | metal |

A still further aspect of the present invention is directed to an electronic travel aid comprising non formal distance scaling involving gait analysis of visually challenged subjects and determining average step length (40 cm) while normal walking which is related to measure distance of obstacle in the front direction for non-formal distance scaling wherein full distance detection range in front direction is divided into integer multiples of said average step length (40 cm) and following:

$$\begin{matrix}m = \frac{d ( s )}{40} & ( 4 ) \\ p = d ( s ) mod 40 & ( 5 )\end{matrix}$$

### Where,

d(s) detected obstacle distance
m no. of steps required to reach obstacle
p remainder
whereby based on values of m and p, generate required non-formal distance scaling.

A further aspect of the present invention is directed to an electronic travel aid adapted for generating dynamic distance of the object/obstacle from subject involving said ultrasonic sensor and microcontroller and integrating non-formal distance scaling with speech messages with choice of full range non-formal distance scaled warning messages in terms of hand or step (Gait analysis based) distances preferably indicative of

| Distance (cm) | Speech message |
|---|---|
| Less than 60 | very close |
| 60 to 79 | two-step distance |
| 80 to 159 | four - steps distance |
| 160 to 239 | six - steps distance |
| 240 to 319 | eight - steps distance |

and/or

| Sr. | | Non-formal distance scaling |
|---|---|---|
| No. | Distance in centimeters | (with speech message) |
| 1 | Less than 70 cm | Object is very close |
| 2 | 70 cm to 79 cm | Object is at one-hand distance |
| 3 | 80 cm to 139 cm | Object is at two-hand distance |
| 4 | 140 cm to 209 cm | Object is at three-hand distance |
| 5 | 210 cm to 279 cm | Object is at four-hand distance |
| 6 | 280 cm to 349 cm | Object is at five-hand distance |
| 7 | 350 cm to 419 cm | Object is at six-hand distance |
| 8 | 420 cm to 500 cm | Object is at seven-hand distance |

According to yet another aspect of the present invention is directed to an electronic travel aid comprising microcontroller means adapted for way-finding with reduced information overload whereby in each sensor cycle (ψ), eight ultrasonic sensors are fired in consistent sequence to generate:

ψ=F(s₁,s₅,s₆)+wₜ+F(s₂,s₇,s₈)+wₜ+F(s₃,s₄,s₅)+wₜ (6)

where,
F(s₁,s₅,s₆) simultaneous firing of s₁, s₅ and s₆ ultrasonic sensors
wₜ waiting time (35 ms)
and wherein such two sensor cycles ψ(i) and ψ(i+1) for recording average distance values detected by individual sensor are involved and implemented with reduced information overload (WRIO), by generating a logical map of surrounding correlating sensor outputs and offer optimized need basis information to the subject with, minimal occlusion of external acoustic signals such that when it infers the presence of the up or down staircase it is adapted to invoke the dedicated routine, where it adaptively fires respective sensors and performs dedicated processing of staircase related data to lead to a practical decision.

A still further aspect of the present invention is directed to an electronic travel aid wherein it maintains a safety margin distance for walking and adapted to avoid collision with possible obstacles in front, left and right direction preferably with variable frequency buzzer beeps for staircase navigation.

A still further aspect of the present invention is directed to an electronic travel aid adapted for maintaining said reduced information overload comprising:
(i) recording said output of sensor cycles ψ(i) and ψ(i+1)

ψ(i)=F(s₁,s₅,s₆)+wₜ+F(s₂,s₇,s₈)+wₜ+F(s₃,s₄,s₅)+wₜ

ψ(i+1)=F(s₁,s₅,s₆)+wₜ+F(s₂,s₇,s₈)+wₜ+F(s₃,s₄,s₅)+wₜ
(ii) comparing detected situations, calculated obstacles distances and their approximate directions.
(iii) construct a logical map of surrounding correlating sensor outputs.
(iv) estimate safety distance margins from possible obstacles in constructed surrounding map.
(v) prioritize received surrounding information; and
(vi) choose desired cue from available options of communication medium (speech messages and variable frequency buzzer beeps) to convey optimum information to the subject including (a) Interrupts: staircase navigation and safety indicators are implemented with variable frequency buzzer beeps and external interrupts respectively and (b) generation of optimum information and cues for relevant surrounding environment.

The present invention is described in greater detail in relation to the non-limiting examples and the accompanying figures.

### BRIEF DESCRIPTION OF FIGURES

FIG. 1 (a): Block Diagram of VENUCANE (Transmitter), 1(b) Block Diagram of VENUCANE (Receiver);

FIG. 2 (a): Front view of VENUCANE, 2(b): Placement of liquid sensor probes and metal sensor, 2(c): Rear view of VENUCANE; 2(d): Microcontroller card; 2(e): Audio recording and playback circuit, 2(f): Smoke detection sensor, 2(g): Liquid detection sensor; 2(h): Metal detection sensor;

FIG. 3: VENUCANE in wireless mode;

FIG. 4: VENUCANE in Wired mode;

FIG. 5: Sample method of usage of VENUCANE;

FIG. 6: Sample test environment with repeated turns;

FIG. 7(a): Detection of up staircase and assistance for up stair, 7(b): Detection of down staircase and assistance for down stair, 7(c): Detection of metallic floor and assistance for navigation.

The above electronic travel aid (ETA) for visually impaired and blind people is thus specifically provided to perform real-time navigation without digital camera and complex hardware and is a true embedded system integrating eight ultrasonic sensor pairs, one smoke (in turn fire) detection sensor, two liquid detection sensors, one metal detection sensor, audio recording and playback flash memory, headphone and buzzer with microcontroller. VENUCANE detects obstacles in front, left and right directions in the range of 5 meters. It can understand floor status (dry/wet/metallic/non-metallic). It can also detect smoke (in turn fire) in the range of 5.30 meters. It keeps conveying all detected and understood situations to subject with pre-recorded speech messages. It offers a wireless/wired low-cost, robust, reliable and user-friendly solution for blind navigation.

VENUCANE is much like white cane. Subject holds the VENUCANE in front of himself/herself while walking. It is audio assisted true embedded navigation system for visually impaired and blind people. VENUCANE is operated at single positive 9V DC power supply.

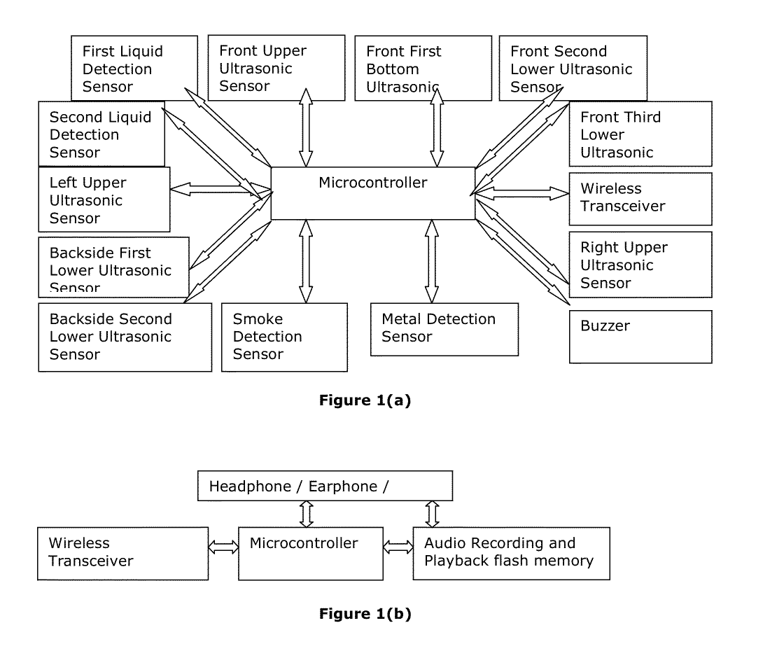

Reference is invited to accompanying FIG. 1 which represents by way of the block diagram the transmitter and receiver part of electronic travel aid (ETA) for visually impaired and blind people in accordance with an embodiment of the invention wherein FIG. 1(a) being representative of the transmitter part and FIG. 1(b) being representative of Receiver parts respectively. Receiver part of VENUCANE shown in FIG. 1(b) is placed in the pocket or sack of subject.

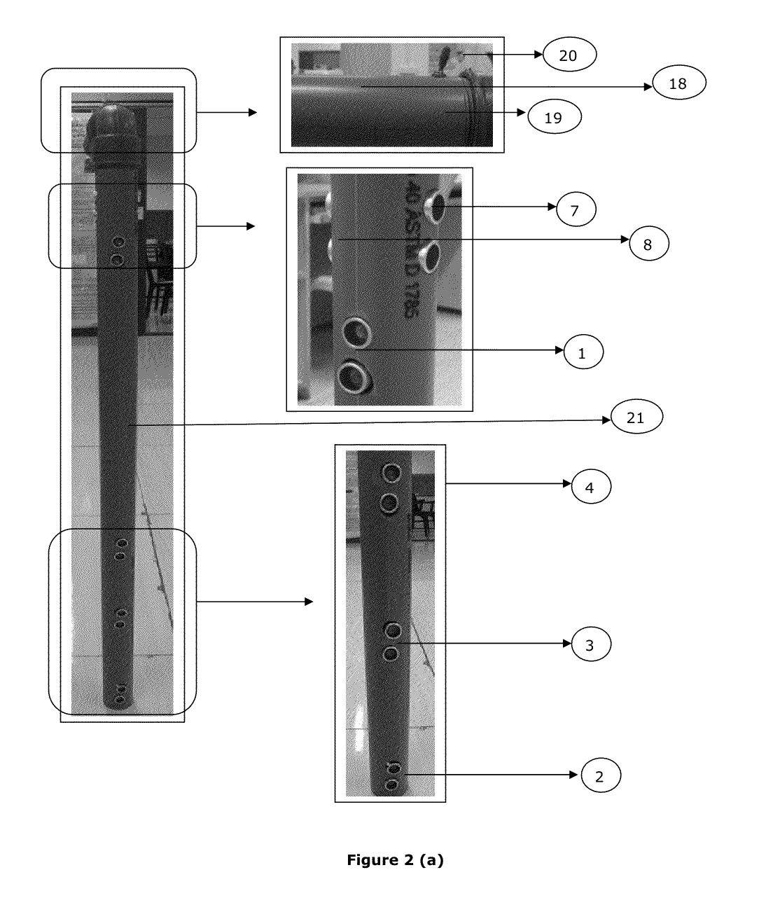

VENUCANE offers both, wireless or wired connectivity between transmitter and receiver. The actual photographs of the VENUCANE system are shown in FIG. 2.

The electronic travel aid (ETA) for visually impaired and blind people/VENUCANE according to the present invention uses a different approach for blind navigation involving:

Detection of Object/Obstacle from Ground Level Height to Head Level Height in Front, Left and Right Direction by Customized Cane Design:

Accompanying FIG. 2 discloses a customized design of VENUCANE. It has eight ultrasonic sensors mounted within. Four ultrasonic sensors are mounted on front side, two sensors are on back side, one sensor on left side and one sensor on right side. There % is a center-grip given on front side. The distance and placement details of ultrasonic sensors on the VENUCANE with reference to ground level (flat surface) are presented in table I.

TABLE 1
Placement details of ultrasonic sensors on VENUCANE

| | | Distance of |
|---|---|---|
| Sensor | Naming | sensor from |
| position | convention | ground level (cm) |
| front lower 1 | s₁ | 07 |
| front lower 2 | s₂ | 26 |
| front lower 3 | s₃ | 48 |
| Front upper | s₄ | 83 |
| rear lower 1 | s₅ | 08 |
| rear lower 2 | s₆ | 27 |
| left side | s₇ | 80 |
| right side | s₈ | 79 |

Using four front sensors, detection of ground level to waist level object/obstacle in front direction is done. Left and right sensors are mounted at waist level height. Detection of left and right side object/obstacle is done using these two side sensors. With offered VENUCANE usage training subject can hold the cane at center putting fingers on grip to detect the head level object/obstacle in any direction. In such situations grip holding keeps correct sensor alignment. Back-side two sensors are used for down stair.

### Detection of Staircase and Assistance for Up Stair & Down Stair:

FIG. 2 shows the placement of eight ultrasonic sensors. Lower three ultrasonic sensors in front direction are placed as per distance details shown in table 1. VENUCANE uses this arrangement for detection of up staircase.

Arrangement of four front side and two rear side ultrasonic sensors on the VENUCANE are used for detection of narrow openings, up and down staircase. VENUCANE infers presence of up staircase in front direction from 139 cm.

VENUCANE uses a new scheme of integration of sensor cycles outcome, beam width calculations and Standard Residential Code for staircase building for detection of up and down staircase. When an ordered structured pattern of distance variation is detected as per formulated mathematical model, presence of up or down staircase is announced. After detecting the drop-off of the top step, VENUCANE ensures presence of pothole or the down staircase using s₁, s₅ and s₆. As per Standard Residential Code for staircase building, table 2 shows maximum dimensions for stair width, tread depth (part of the staircase that is stepped on) and riser height (vertical portion between each tread on the stair). Subject can go upstairs or downstairs with audio assistance and can understand the end of staircase with the help of speech message. An algorithm for detection of staircase is presented below.

TABLE 2
Standard residential code for staircase building

| Particulars | Size (cm) |
|---|---|
| Stair width | 91.4 |
| Riser height | 19.6 |
| Tread depth | 25.4 |

### Let,

d(x) distance detected by a sensor (cm)
x tread depth (cm)
e error between theoretical and actual reading

### Algorithm

### Input:

Riser height and tread depth

### Iteration:

(i) Average distance readings d(s₁), d(s₂), d(s₃), d(s₄) d(s₅) and d(s₆) obtained from sensor cycles ψ(i) and ψ(i+1)
(ii) Verify:

d(s₄)≅d(s₃)+x+e (1)

d(s₃)≅d(s₂)+x+e (2)

d(s₂)≅d(s₁)+x+e (3)
(iii) Correlation between d(s₁), d(s₅) and d(s₆)
(iv) Compute distance values for x and error value e
(v) Compute a pattern based on detected distances values
(vi) If pattern indicates presence of up or down staircase, announce it using speech message and guide the subject using buzzer beep to proceed on the staircase.

### Output:

### Consistent Detection and Assistance for Staircase

Two ultrasonic sensors are mounted on lower back-side of VENUCANE. These two sensors are placed as per distance details shown in table 1 and are exclusively used for detection of down staircase. Subject can down stair and can understand the end of staircase with the help of stored speech messages. Range of these two sensors are deliberately kept from 0 cm to 20 cm. VENUCANE uses ultrasonic sensors for object/obstacle detection, staircase detection, up stair and down stair application. An ultrasonic sensors work on echoes from sound waves, ambient light/conditions does not affect them. Ultrasonic sensor distance range (5 meter) and performance is extremely better than infra-red sensors (Prior art: RecogizeCane). Infra-red sensors support very small distance range (few centimeters) for operation, may be falsely triggered at ambient light/conditions and give wrong results.

### Safety Indicators:

While walking on indoor or outdoor environment, surrounding as well as floor/surface information is very important for subject. For understanding such information, VENUCANE uses smoke (in turn fire) detection sensor, liquid detection sensors and metal detection sensor. Life threatening injuries can be avoided by having such information well in advance.

With the help of smoke and gas detector sensor, subject can understand the presence of smoke/fire/gas leakage from a far distance.

With the help of metal detector sensor, subject can understand metallic floor, metallic fencing/casing etc.

Presence of liquid can be understood with the help of liquid detection sensor. Nowadays marbled tiles are commonly used for flooring. If water spills on these surfaces, even a normal person will not be able to notice it. If the floor is wet and becomes slippery, subject may fall down and it may lead to life threatening injuries. In such situations, VENUCANE alerts the subject in advance. Liquid detection sensor probes are mounted on the bottom periphery of the cane. VENUCANE gives highest priority to safety of the subject. Table 3 shows VENUCANE supported priority structure for safety indicators.

TABLE 3
Priority structure for safety indicators in VENUCANE

| Sr. No. | Sensor and event | Priority |
|---|---|---|
| 1 | Smoke (in turn fire) detection | 1 |
| 2 | Wet floor detection | 2 |
| 3 | Metallic floor detection | 3 |

In VENUCANE, Safety indications are implemented using external interrupts of microcontroller. Smoke detection is implemented with external interrupt 0 and liquid as well as metal detection is implemented with external interrupt 1 of microcontroller. VENUCANE uses different approach for correct understanding of presence of liquid and metal on the floor.

Liquid detection sensors works on the conductivity principle. Liquid detection sensor has two probes (wires). When these probes comes on the liquid (water, milk, oil, mud, etc) based on conductivity, sensor understands the presence of liquid. Metals are the prime conductors. When these probes come on metal, due to metal conductivity, liquid detection sensor wrongly identify metal as liquid. (Prior art: RecognizeCane)

VENUCANE uses two liquid detection sensors and one metal detection sensor for correct understanding of liquid and metal on the floor. Two probes of first liquid detection sensor are mounted on the bottom periphery of the VENUCANE with some spacing. Metal detection sensor is mounted inside at 2 cm height from ground. Two probes of second liquid detection sensor are insulated and are mounted above metal detection sensor. VENUCANE discriminates presence of liquid and metal based on Table 4.

TABLE 4
Basis for liquid and metal discrimination by VENUCANE

| | Output of | Output | Output of | Discrimination |
|---|---|---|---|---|
| | first liquid | of metal | second liquid | of liquid and |
| Sr. | detection | detection | detection | metal by |
| No. | sensor | sensor | sensor | VENUCANE |
| 1 | NO | NO | NA* | None |
| 2 | NO | Yes | NA* | Metal |
| 3 | Yes | NO | NA* | Liquid |
| 4 | Yes | Yes | No | Metal |
| 5 | Yes | Yes | Yes | Both liquid and metal |

VENUCANE considers output of second liquid detection sensor only when both, liquid and metal detection sensor gives positive answer. Using table 4 VENUCANE takes correct decision. Second liquid detector sensor is also used for understanding the level of liquid on the floor.
*NA: Not applicable (do not care)

### Non-Formal/Formal Obstacle Distance Scaling:

As per prior art, many inventors have detected the distant object/obstacle around the subject. Inventors have represented the distance of the obstacle from subject with tactile sensors, haptics or buzzer based audio frequency clips. Some have used text to speech conversion for announcing such distance.

VENUCANE calculates dynamic distance of the object/obstacle from subject using ultrasonic sensor and microcontroller. It can understand 5 meters distant object/obstacle in any direction. VENUCANE can announce calculated real time distance as it is in meters or centimeters using speech messages. To make distance understanding more appealing VENUCANE uses non-formal obstacle scaling approach. Sample non-formal obstacle distance scaling is shown in Table 5.

TABLE 5
Sample non-formal obstacle distance scaling for VENUCANE

| Sr. | Distance in | Non-formal distance scaling |
|---|---|---|
| No. | centimeters | (with speech message) |
| 1 | Less than 70 cm | Object is very close |
| 2 | 70 cm to 79 cm | Object is at one-hand distance |
| 3 | 80 cm to 139 cm | Object is at two-hand distance |
| 4 | 140 cm to 209 cm | Object is at three-hand distance |
| 5 | 210 cm to 279 cm | Object is at four-hand distance |
| 6 | 280 cm to 349 cm | Object is at five-hand distance |
| 7 | 350 cm to 419 cm | Object is at six-hand distance |
| 8 | 420 cm to 500 cm | Object is at seven-hand distance |

Based on Gait analysis of visually challenged subjects, average step length (40 cm) is found while normal walking and can be related with distance of obstacle in the front direction for non-formal distance scaling. Full distance detection range in front direction can be divided into integer multiples of 40 cm.

$$\begin{matrix}m = \frac{d ( s )}{40} & ( 4 ) \\ p = d ( s ) mod 40 & ( 5 )\end{matrix}$$

Where,
d(s) detected obstacle distance
m no. of steps required to reach obstacle
p remainder

Based on values of m and p, effectively non-formal distance scaling can be accomplished. Gait analysis based sample non-formal distance scaling messages for front direction are presented in table 6.

Choice of full range non-formal distance scaled warning messages in terms of hand or step (Gait analysis based) distances is given to the subject. Default operation uses hand distance based non-formal distance scaling.

TABLE 6
Sample non-formal distance (front direction) scaling messages

| Distance (cm) | Speech message |
|---|---|
| Less than 60 | very close |
| 60 to 79 | two-step distance |
| 80 to 159 | four-steps distance |
| 160 to 239 | six-steps distance |
| 240 to 319 | eight-steps distance |

### Speech Warning Messages for Conveying Detected Conditions to Subject:

As per prior art, many inventors used vibration array, buzzer based audio frequency clips or text to speech conversion for announcing any detected condition to the subject. VENUCANE uses pre-recorded speech messages for conveying any detected condition to the subject. VENUCANE uses audio recording and playback flash memory. It can store sixty-four speech messages each of 7.5 sec. duration. Number of messages can be increased by reducing the duration of each message. Microcontroller processes real-time data collected by ultrasonic, smoke detection, liquid detection and metal detection sensor and takes the correct decision. Based on decision, relevant message is invoked from the flash memory and conveyed to the subject through headphone.

New algorithms for way-finding with reduced information overload is implemented with used microcontroller. As per eq. (6), in each sensor cycle (ψ), eight ultrasonic sensors are fired in consistent sequence.

ψ=F(s₁,s₅,s₆)+wₜ+F(s₂,s₇,s₈)+wₜ+F(s₃,s₄,s₅)+wₜ (6)

where,
F(s₁,s₅,s₆) simultaneous firing of s₁, s₅ and s₆ ultrasonic sensors
wₜ waiting time (35 ms)

Such two sensor cycles ψ(i) and ψ(i+1) are used for recording average distance values detected by individual sensor. In real time environment the rate of generation of new information is quite high and conveying such huge information directly to the subject may create confusion and affect mobility.

### Algorithm:

A new algorithm is implemented for Way-finding with Reduced Information Overload (WRIO), which constructs the logical map of surrounding correlating sensor outputs and offers optimized need basis information to the subject with minimal occlusion of external acoustic signals. When it infers the presence of the up or down staircase it invokes the dedicated routine, where it adaptively fires respective sensors and performs dedicated processing of staircase related data to lead to a practical decision. Variable frequency buzzer beeps are used for staircase navigation. VENUCANE constructs a logical map of surrounding with 500 cm radial distance in front, left and right direction of the subject. System maintains a safety margin distance for walking and helps to avoid collision with possible obstacles in front, left and right direction.

### WRIO Algorithm

### Iteration:

Record output of sensor cycles ψ(i) and ψ(i+1)

ψ(i)=F(s₁,s₅,s₆)+wₜ+F(s₂,s₇,s₈)+wₜ+F(s₃,s₄,s₅)+wₜ

ψ(i+1)=F(s₁,s₅,s₆)+wₜ+F(s₂,s₇,s₈)+wₜ+F(s₃,s₄,s₅)+wₜ

Compare detected situations, calculated obstacles distances and their approximate directions.

Construct a logical map of surrounding correlating sensor outputs.

Estimate safety distance margins from possible obstacles in constructed surrounding map.

Prioritize received surrounding information.

Choose desired cue from available options of communication medium (speech messages and variable frequency buzzer beeps) to convey optimum information to the subject.

### Interrupts:

Staircase navigation and safety indicators are implemented with variable frequency buzzer beeps and external interrupts respectively.

### Output:

Generation of optimum information and cues for relevant surrounding environment.

### Flexibility to Use any Language for Speech Warning Messages:

As per prior art, for speech assisted navigation, many inventors are using text to speech conversion. In such cases inventors are converting text into English language only. As VENUCANE uses flash memory to store the pre-recorded speech messages, there is no barrier for usage of any language. Any appealing universal language can be used for recording speech warning messages. VENUCANE offers a simple mechanism for recording and storing such speech warning messages.

VENUCANE has two major sections:
1. Data Collection and Processing Section (DCPS) and
2. Speech Announcement Section (SAS)

### 1. Data Collection and Processing Section (DCPS):

This section forms the transmitter part of VENUCANE and it is placed within the hollow VENUCANE. DCPS further has three sections.
1. Vision section
2. Safety section
3. Decision and control section
   DCPS Vision section:

In VENUCANE, vision is implemented using a network of eight pairs of ultrasonic sensors. Sensor placement is shown in FIG. 2. Four ultrasonic sensors are mounted on front side, two sensors are on back side, one sensor on left side and one sensor on right side. There is a center-grip given on front side. Placement and distance details of front ultrasonic sensors are shown in table 1. Using these four sensors, detection of ground level to waist level object/obstacle in front direction is done. Detection of left and right side object/obstacle is done using left and right side sensors. With offered usage training, subject can hold the VENUCANE at center putting fingers on grip to detect the head level object/obstacle in any direction. In such situations grip holding keeps correct sensor alignment.

Description of different components of the system as disclosed in accompanying FIGS. 2(a)-2(h) are as follows:

1. Front upper ultrasonic sensor; 2. Front first bottom ultrasonic sensor; 3. Front second lower ultrasonic sensor; 4. Front third lower ultrasonic sensor; 5. Back-side first lower ultrasonic sensor; 6. Back-side second lower ultrasonic sensor; 7. Left upper ultrasonic sensor; 8. Right upper ultrasonic sensor; 9. Smoke detection sensor (inside cane); 10. Window for smoke detection sensor; 11. Liquid detection sensors (inside cane); 12. First liquid detection sensor probes; 13. Second liquid detection sensor probes; 14. Metal detection sensor (inside cane); 15. Audio recording and playback flash memory (VENUCANE receiver); 16. MICROCONTROLLER Microcontroller Card (inside cane); 17. Wireless transceiver; 18. Buzzer (inside VENUCANE handle); 19. 9V DC Battery (inside VENUCANE handle); 20. On-off switch; 21. Center grip.

Placement and distance details of lower three ultrasonic sensors in front direction are shown in table 1. VENUCANE uses this arrangement for detection of up staircase. An interrelated structured pattern of distance variation detected by these three sensors is used for detection of staircase. Repeated sampling of data is done for concluding staircase detection. Subject can up stair and can understand the end of staircase with the help of stored speech messages. Two ultrasonic sensors are mounted on lower back-side of VENUCANE. Placement and distance details of these sensors are shown in table 1 and are exclusively used for detection of down staircase. Subject can down stair and can understand the end of staircase with the help of stored speech messages. Range of these two sensors is intentionally kept from 0 cm to 20 cm. VENUCANE uses ultrasonic sensors for object/obstacle detection, staircase detection, up stair and down stair application. VENUCANE calculates dynamic distance of the object/obstacle from subject using ultrasonic sensor and microcontroller. It can understand 5 meters distant object/obstacle in any direction. VENUCANE can announce calculated real time distance as it is in meters or centimeters using speech messages. To make distance understanding more appealing VENUCANE uses non-formal obstacle scaling approach. Sample non-formal obstacle distance scaling is shown in Table 7.

TABLE 7
Sample non-formal obstacle distance scaling for VENUCANE

| Sr. | Distance in | Non-formal distance scaling |
|---|---|---|
| No. | centimeters | ( speech message warning) |
| 1 | Less than 70 cm | Obstacle is very close |
| 2 | 70 cm to 79 cm | Obstacle is at one-hand distance |
| 3 | 80 cm to 139 cm | Obstacle is at two-hand distance |
| 4 | 140 cm to 209 cm | Obstacle is at three-hand distance |
| 5 | 210 cm to 279 cm | Obstacle is at four-hand distance |
| 6 | 280 cm to 349 cm | Obstacle is at five-hand distance |
| 7 | 350 cm to 419 cm | Obstacle is at six-hand distance |
| 8 | 420 cm to 500 cm | Obstacle is at seven-hand |
| | | distance |

As ultrasonic sensors work on echoes from sound waves, ambient light/conditions does not affect them. Ultrasonic sensor distance range (5 meter) and performance is extremely better than infra-red sensors. Infra-red sensors support very small distance range (few centimeters) for operation, may be falsely triggered at ambient light/conditions and give wrong results.

### DCPS Safety Section:

While walking on indoor or outdoor environment, surrounding as well as floor/surface information is very important for subject. For understanding such information, VENUCANE uses smoke (in turn fire) detection sensor, liquid detection sensors and metal detection sensor. Life threatening injuries can be avoided by having such information well in advance. With the help of smoke and gas detector sensor, subject can understand the presence of smoke/fire/gas leakage from a far distance. With the help of metal detector sensor, subject can understand metallic floor, metallic fencing/casing etc. Presence of liquid can be understood with the help of liquid detection sensor. Now days marbled tiles are commonly used for flooring. If water spills on these surfaces, even a normal person will not be able to notice it. If the floor is wet and becomes slippery, subject may fall down and it may lead to life threatening injuries. In such situations, VENUCANE alerts the subject in advance. Liquid detection sensor probes are mounted on the bottom periphery of the cane. VENUCANE gives highest priority to safety of the subject. Table 8 shows VENUCANE supported priority structure for safety indicators.

TABLE 8
Priority structure for safety indicators in VENUCANE

| Sr. No. | Sensor and event | Priority |
|---|---|---|
| 1 | Smoke (in turn fire) detection | 1 |
| 2 | Wet floor detection | 2 |
| 3 | Metallic floor detection | 3 |

In VENUCANE, Safety indications are implemented using external interrupts of microcontroller. Smoke detection is implemented with external interrupt 0 and liquid as well as metal detection is implemented with external interrupt 1 of microcontroller. Liquid detection sensors works on the conductivity principle. Liquid detection sensor has two probes (wires). When these probes comes on the liquid (water, milk, oil, mud, etc) based on conductivity, sensor understands the presence of liquid. Metals are the prime conductors. When these probes come on metal, due to metal conductivity, liquid detection sensor wrongly identify metal as liquid. VENUCANE uses two liquid detection sensors and one metal detection sensor for correct understanding of liquid and mental on the floor. Two probes of first liquid detection sensor are mounted on the bottom periphery of the VENUCANE with some spacing. Metal detection sensor is mounted inside at 2 cm height from ground. Two probes of second liquid detection sensor are insulated and are mounted above metal detection sensor. VENUCANE discriminates presence of liquid and metal based on Table 9.

TABLE 9
Basis for liquid and metal discrimination by VENUCANE

| | Output of first | Output | Output of | Discrimination |
|---|---|---|---|---|
| | liquid | of metal | second | of liquid |
| Sr. | detection | detection | liquid detection | and metal by |
| No. | sensor | sensor | sensor | VENUCANE |
| 1 | NO | NO | NA* | None |
| 2 | NO | Yes | NA* | Metal |
| 3 | Yes | NO | NA* | Liquid |
| 4 | Yes | Yes | No | Metal |
| 5 | Yes | Yes | Yes | Both liquid |
| | | | | and metal |

*NA: Not applicable (do not care)

VENUCANE considers output of second liquid detection sensor only when both, liquid and metal detection sensor gives positive answer. Using table 2 VENUCANE takes correct decision. Second liquid detector sensor is also used for understanding the level of liquid on the floor. When Obstacles are detected in front, left and right direction, VENUCANE put on the buzzer within for 1 minute indicating all side obstacle situations.

### DCPS Decision and Control Section:

An 8-bit microcontroller, clocked at 11.0592 MHz. is used for processing real-time data collected by all above mentioned sensors. Real-time navigation is performed with scaled obstacle distance warning and effective usage of interrupts of microcontroller. Repeated sampling of data is performed before taking a decision. Microcontroller invokes the stored pre-recorded speech messages based on the real-time detected and understood issues.

### 2. Speech Announcement Section (SAS):

VENUCANE uses pre-recorded speech messages for conveying any detected condition to the subject. VENUCANE uses audio recording and playback flash memory. It can store sixty-four speech messages each of 7.5 sec. duration. Number of messages can be increased by reducing the duration of each message. Microcontroller processes real-time data collected by ultrasonic, smoke detection, liquid detection and metal detection sensor and takes the correct decision. Based on decision, relevant message is invoked from the flash memory and conveyed to the subject through headphone. As VENUCANE uses flash memory to store the pre-recorded speech messages, there is no barrier for usage of any language. Any appealing (for subject) universal language can be used for recording speech warning messages. VENUCANE offers a simple mechanism for recording and storing such speech warning messages.

Based on communication between these two sections, DCPS and SAS, VENUCANE has two modes of operation:

A. Wireless mode
B. Wired mode

### A. Wireless Mode:

In wireless mode, a wireless connectivity is used for sharing decisions and invoking relevant speech messages between DCPS and SAS. In this mode half duplex wireless communication is implemented using 2.

4 GHz operated Radio Frequency (RF) modem. A baud rate of 9600 bits per second (bps) is used for this communication.

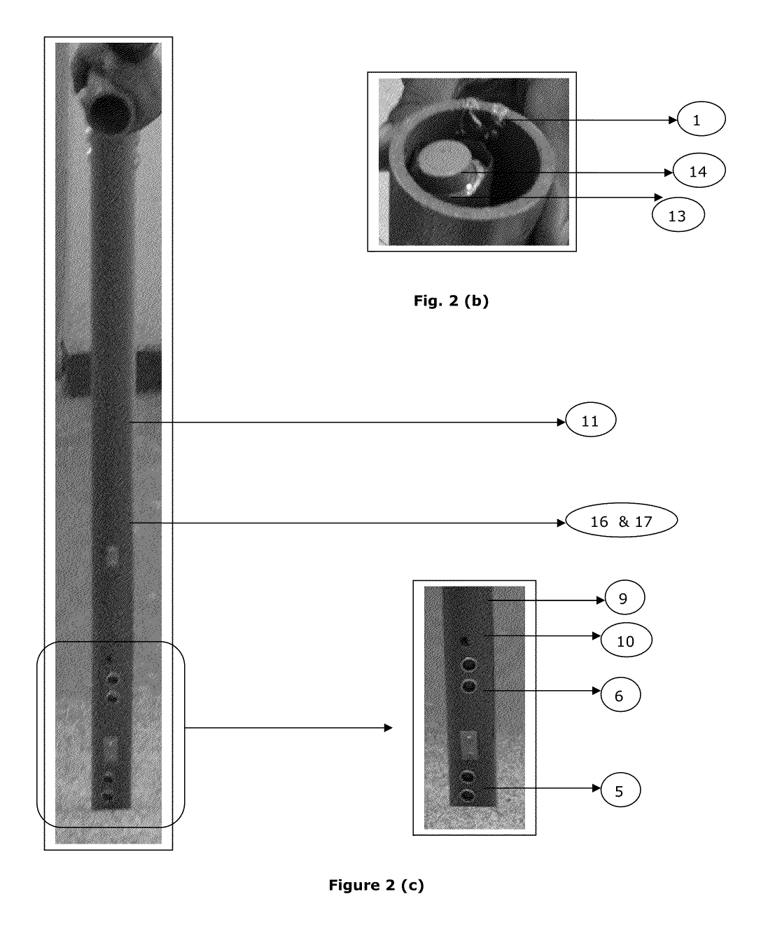

FIG. 3 shows the VENUCANE system in wireless mode.

### B. Wired Mode:

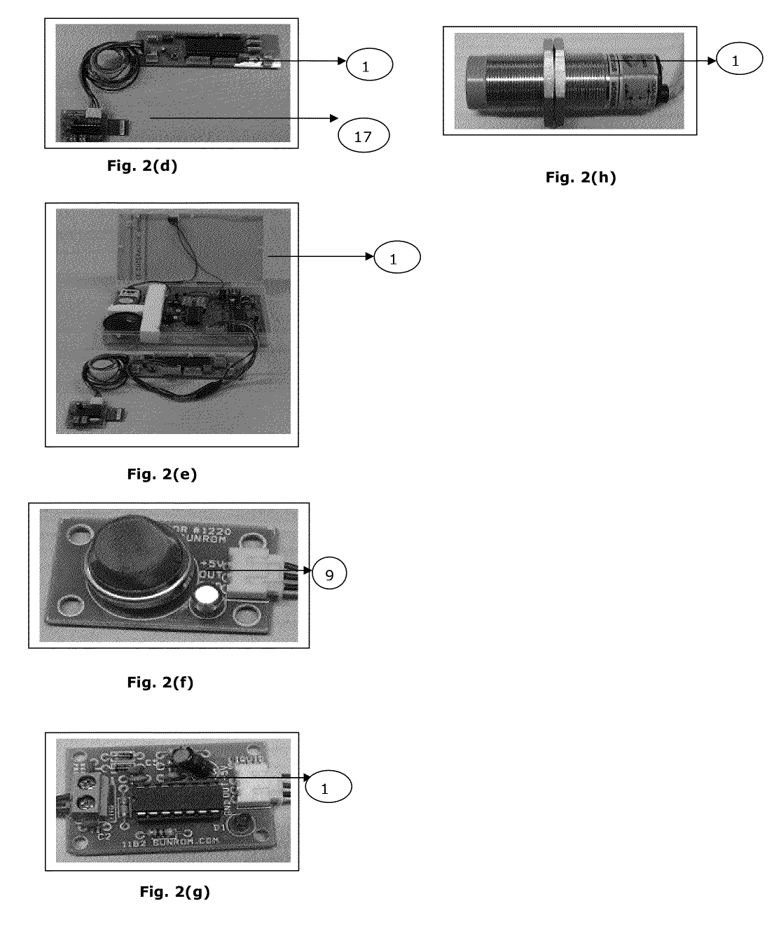

In wired mode, there is detachable connector between DCPS and SAS. This connector carries the decisions to invoke relevant message stored in the speech section. In this mode both wireless transceivers at transmitter and receiver end are disabled. FIG. 4 shows the VENUCANE system in wireless mode.

Based on subject requirement any mode can be chosen for navigation. Mode selection switch is given in the VENUCANE. Both modes are comfortable for navigation. Wireless mode reduces physical interface with the subject.

### Best Method of Usage:

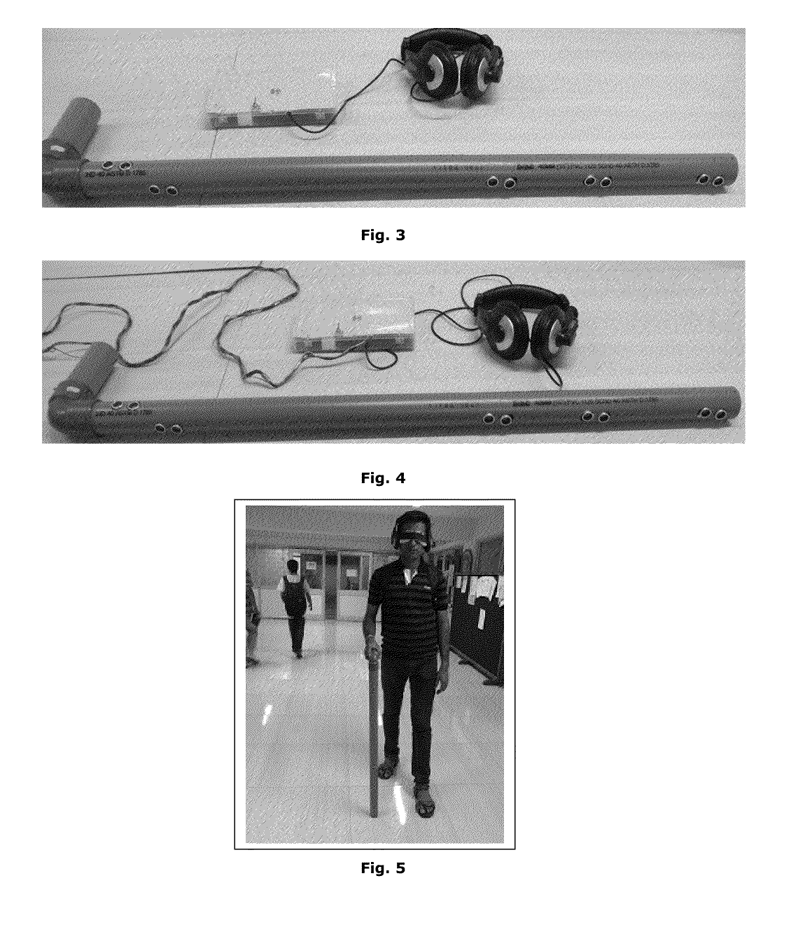

VENUCANE is designed considering ergonomic issues. Subject should hold the VENUCANE in front of him/her, perpendicular to the ground. There should be at least 20 to 30 cm distance between subject and cane for comfortable walking. Method of usage of VENUCANE is shown in FIG. 5 wherein the subject is encouraged to scan head level obstacle whenever he/she encounters bottom or waist level height obstacle in any direction.

### Testing Details:

Testing of all used sensors, their functions and features are performed on individual and as a system. Ultrasonic sensor pairs, liquid detection sensor, metal detection sensor and fire detection sensor are tested for their range, accuracy and repeatability. Range details and sensor connections with microcontroller are presented in Table 10.

TABLE 10
Sensor and other connections, theoretical and verified range

| | | | Sensor |
|---|---|---|---|
| | | | connection |
| Sr. | | Range | with |
| No. | Sensor | (meters) | Microcontroller |
| 1 | Front upper ultrasonic sensor | 05.00 | P2.0, P2.1 |
| 2 | Front first bottom ultrasonic sensor | 05.00 | P2.2, P2.3 |
| 3 | Front second lower ultrasonic sensor | 05.00 | P2.4, P2.5 |
| 4 | Front third lower ultrasonic sensor | 05.00 | P2.6, P2.7 |
| 5 | Back-side first lower ultrasonic | 05.00 | P0.0, P0.1 |
| | sensor | | |
| 6 | Back-side second lower ultrasonic | 05.00 | P0.2, P0.3 |
| | sensor | | |
| 7 | Right upper ultrasonic sensor | 05.00 | P0.4, P0.5 |
| 8 | Left upper ultrasonic sensor | 05.00 | P0.6, P0.7 |
| 9 | Smoke detection sensor | 06 | P3.2 |
| 10 | First liquid detection sensor | contact | P3.3 |
| 11 | Second liquid detection sensor | contact | P3.4 |
| 12 | Metal detection sensor | 00.01 | P3.5 |
| 13 | Wireless RF transceivers | 30 | P3.0, P3.1 |
| 14 | Buzzer | NA | P3.6 |
| 15 | Mode selection switch | NA | P3.7 |
| 16 | Audio Recording and Playback | NA | P1.0 to P1.7 |
| | memory | | |

* NA: Not applicable

Obstacle distance scaling is done in a chunk of 70 cm each. For better appreciation of distance, 70 cm distance is treated as one-hand long distance from subject.

### Performance Evaluation:

To evaluate the performance, VENUCANE is tested on trained and novice people in the indoor and outdoor environment. Basic training is required on VENUCANE for its smooth usage. A total of eight performances have been recorded. Four performances without staircase and four with staircase are recorded on a set of four blind folded subjects in indoor and outdoor like environment. In this set two are trained subjects and two are novice subjects.

Test Environment with Repeated Turns:

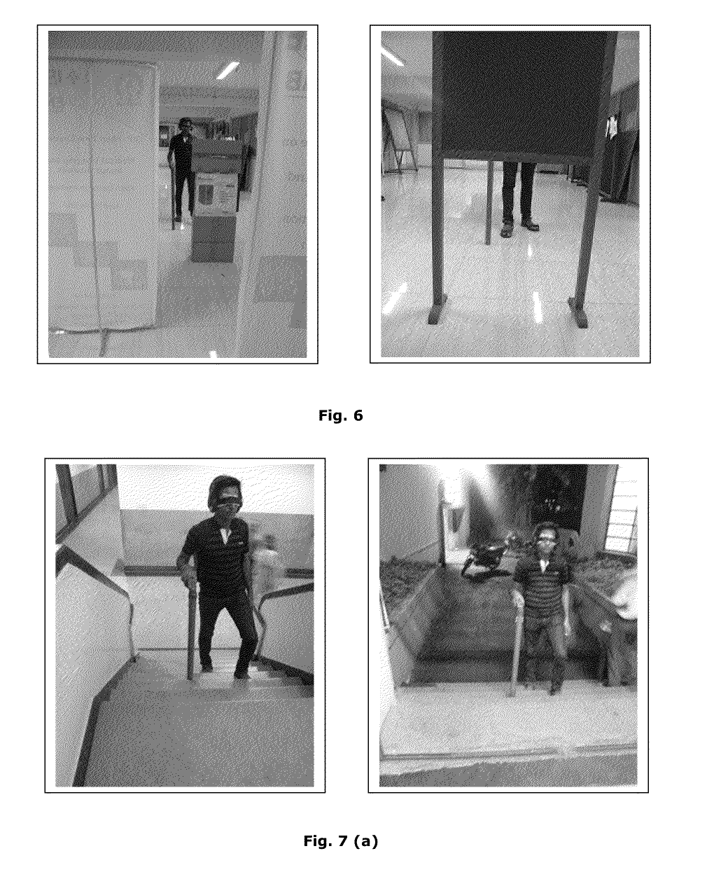

After blindfolding, the subject is asked to walk where different type of obstacles has been placed in front, left and right direction within 15 meter range. Obstacles and other situations set-up is prepared for indoor test environment as shown in FIG. 6.

Details of obstacle placement and distance for test environment are given in table 11.

TABLE 11
Obstacles and situations set-up for test environment with repeated turns

| Sr. | | Distance from |
|---|---|---|
| No. | Obstacles location/Conditions | subject (meters) |
| 1 | Obstacle at front bottom, left and right | 2 |
| 2 | Obstacle at front upper and left | 4 |
| 3 | Obstacle at front upper and right | 6 |
| 4 | Obstacle at front upper bottom, front head level | 8 |
| | and right | |
| 5 | Wet floor | 12 |
| 6 | Obstacle at front, left and right | 15 |

Time taken by the trained and novice subjects for successfully walking through this test environment is measured and travel speed for trained and novice subject has been calculated and presented in table 12.

TABLE 12
Subject performance table for test environment with repeated turns

| | | No. of | No. of | No. of | |
|---|---|---|---|---|---|
| | | obstacles/ | obstacles/ | Obstacles/ | |
| | | conditions | conditions | conditions | |
| Sr. | Subject | placed | detected | cleared | Travel speed |
| No. | type | in test | in test | successfully | (meter/sec.) |
| 1 | Novice | 06 | 06 | 06 | 0.47 |
| 2 | Novice | 06 | 06 | 06 | 0.49 |
| 3 | Trained | 06 | 06 | 06 | 0.71 |
| 4 | Trained | 06 | 06 | 06 | 0.75 |

Test Environment with Up and Down Staircase:

This performance test is carried on two trained and two novice subjects.

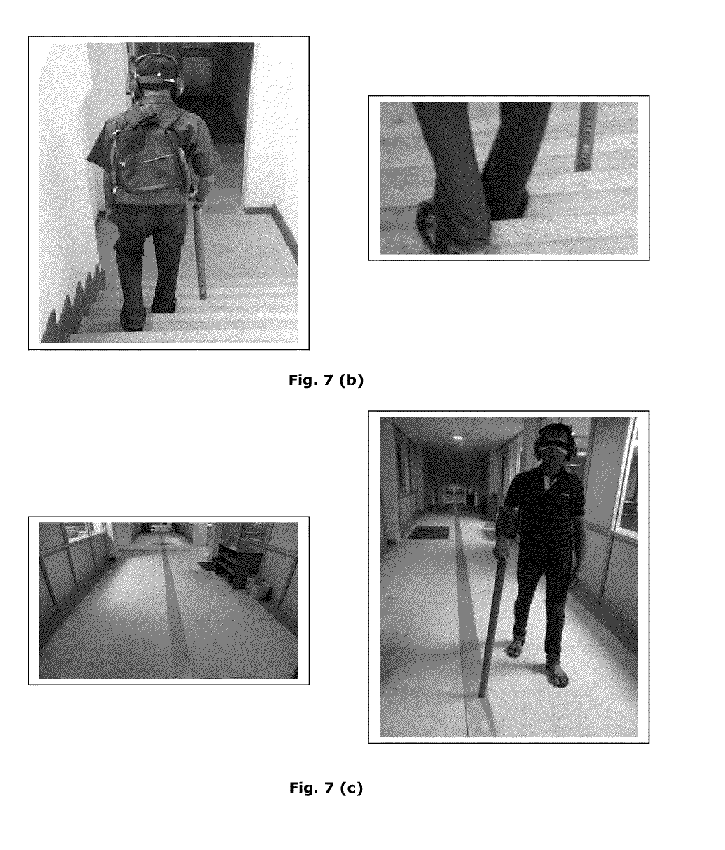

After blindfolding, the subject is asked to walk where different type of obstacles has been placed in front, left and right direction within 30 meter range. Obstacles and other situations sample set-up with metallic floor, up and down staircase is chosen for this test environment as shown in FIGS. 7(a), (b) and (c).

Details of this test environment are given in table 13

TABLE 13
Test environment with up and down staircase

| Sr. | | Distance from |
|---|---|---|
| No. | Obstacles location/Conditions | subject (meters) |
| 1 | Obstacle at front and left | 2 |
| 2 | Up staircase | 4 |
| 3 | Obstacle at left and front | 9 |
| 4 | Wet down staircase | 10 |
| 5 | Metallic floor | 16 |
| 6 | Obstacle at front upper and right | 20 |
| 7 | Fire around | 25 |
| 8 | Obstacle at front, left and right | 30 |

Time taken by the trained and novice subjects for successfully walking through this test environment is measured and travel speed for trained and novice subject has been calculated and presented in table 14.

TABLE 14
Performance table for test environment with up and down staircase

| | | No. of | | No. of | |
|---|---|---|---|---|---|
| | | obstacles/ | No. of | Obstacles/ | |
| | | conditions | obstacles/ | condtns. | |
| Sr. | Subject | placed | conditions | cleared | Travel speed |
| No. | type | in test | detected in test | Successfully | (meter/sec.) |
| 1 | Novice | 08 | 08 | 08 | 0.35 |
| 2 | Novice | 08 | 08 | 08 | 0.38 |
| 3 | Trained | 08 | 08 | 08 | 0.65 |
| 4 | Trained | 08 | 08 | 08 | 0.63 |

Above readings are recorded by imparting a training of 14 hours (one week) to blindfolded subjects. Regular use of VENUCANE will improve the travel speed of trained subject.

During above two tests, while navigating, VENUCANE invoked sample non-formal distance scaling and situation based speech messages are presented in table 15

TABLE 15
VENUCANE invoked sample speech messages

| Sr. | Distance of obstacle | Non-formal distance scaling |
|---|---|---|
| No. | from subject | (speech message warning) |
| 1 | Less than 70 cm | Obstacle is very close |
| 2 | 70 cm to 79 cm | Obstacle is at one-hand distance |
| 3 | 80 cm to 139 cm | Obstacle is at two-hand distance |
| 4 | 140 cm to 209 cm | Obstacle is at three-hand distance |
| 5 | 210 cm to 279 cm | Obstacle is at four-hand distance |
| 6 | 280 cm to 349 cm | Obstacle is at five-hand distance |
| 7 | 350 cm to 419 cm | Obstacle is at six-hand distance |
| 8 | 420 cm to 500 cm | Obstacle is at seven-hand distance |
| | Detected situations | Speech message warning |
| 9 | When obstacle is at 70 cm | Obstacle is very close to foot |
| | or less from front first | |
| | bottom sensor | |
| 10 | When obstacle is at foot level | You are encouraged to perform head |
| | height or at waist level height | level height test |
| 11 | When obstacle is at 70 cm or | Go straight |
| | less from left and right side | |
| 12 | When obstacle is at 70 cm or | Take careful right turn |
| | less from front and left side | |
| 13 | When obstacle is at 70 cm or less | Take careful left turn |
| | from front and right side | |
| 14 | When up staircase is in front | Up staircase is detected in front |
| | at 139 cm or less | |
| 15 | While up stair | This is not end of up staircase |
| 16 | When up staircase ends | Up staircase ends here |
| 17 | When down staircase is detected | Be careful down staircase is detected |
| 18 | While down stair | This is not end of down staircase |
| 19 | When down staircase ends | Down staircase ends here |
| 20 | When floor is wet | Floor is wet. Walk carefully |
| 21 | When floor is metallic | Its metallic floor. Walk carefully |
| 22 | When liquid level is above | Liquid level is above 2 cm height |
| | 2 cm height | |
| 23 | When subjects comes near | Fire is detected around. Be careful |
| | smoke/fire | |
| 24 | When mode selection switch | This is VENUCANE wireless mode |
| | selects wireless mode | |
| 25 | When mode selection switch | This is VENUCANE wired mode |
| | selects wired mode | |
| 26 | When obstacle is at 70 cm or | Obstacles are at all sides. Ask for |
| | less from front, left and right side | help. (It also buzzer for 10 seconds) |

The electronic travel aid (ETA) for visually impaired and blind people/VENUCANE thus performs integration of relevant sensors for conforming obstacle distance and detected situation. VENUCANE is further adapted to involve repeated data sampling and averaging methods to resolve any obstacle distance or situation conflict.

It is thus possible by way of the present invention to provide for electronic travel aid (ETA) for visually impaired and blind people, to assist visually impaired and blind subjects with vision disability with the following unique and technically advanced features including:
1. Customized cane design and placement of sensors
2. Wireless and Wired mode of operation
3. Obstacle detection in front, left and right direction
4. Obstacle detection from ground level to head level height in front, left and right direction
5. Speech based announcement for detected obstacle/condition
6. Non-formal distance scaling for detected obstacles
7. Detection of up staircase
8. Speech based assistance to up stair
9. Detection of down staircase
10. Speech based assistance to down stair
11. Smoke (in turn) fire detection
12. Liquid and liquid level detection
13. Metal detection
14. Flexibility to use any universal language for speech messages

Advantages of electronic travel aid (ETA) for visually impaired and blind people/VENUCANE include:

1. Obstacle detection in front, left and right direction
2. Obstacle detection from ground level to head level height in front left and right direction
3. Staircase navigation
4. Speech based announcement for detected obstacle/condition
5. Non-formal distance scaling for detected obstacles
6. Safety indicators for smoke, liquid and metal
7. Less training time
8. Low power consumption
9. Light weight

### 10. Portable

### 11. Robust

### 12. Affordable

13. Minimum physical interface with the subject

1. An electronic travel aid enabling real-time navigation for visually impaired and blind people comprising:
a walking stick like implement/cane comprising selectively disposed object/obstacle detection sensor means adapted for object/obstacle detection from ground level to waist level height of subject in any direction including staircase detection, up stair and down stair application and safety indicating sensors selected from anyone or more of smoke detection sensor, liquid detection sensors, metal detection sensor;
microcontroller and transceiver means adapted to receive the sensor inputs, thereby perform real time navigation to enable detection of non-formal/formal obstacles and generating outputs including distance scaled different warning speech messages indicating the said obstacles distance for assisting the visually impaired and blind people; and
said microcontroller means for providing said real time navigation includes recording of and comparing of the sensor outputs and constructing a logical map of surrounding by correlating sensor outputs; estimating safety distance margins from possible obstacles in constructed surrounding map and prioritize received surrounding information; and conveying optimum information and cues for relevant surrounding environment;
operative power source.

2. The electronic travel aid according to claim 1 comprising:
transmitter part embedded in said walking stick like implement/cane preferably having a grip means at the front including (a) ground level to waist level object/obstacle detection sensor means comprising eight ultrasonic sensors mounted within comprising of four ultrasonic sensors mounted on front side, two sensors on back side, one sensor on left side and one sensor on right side and (b) said safety indicating sensors comprising embedded ultrasonic sensor pairs including smoke/fire detection sensor, liquid detection sensor and metal detection sensor (c) said microcontroller and wireless transceiver means;
operatively connected receiver part comprising wireless transceiver, microcontroller and audio means adapted to generate audio outputs preferably selected from buzzer, pre-recorded messages/speeches, audio recording and playback flash memory for generating outputs for assisting the visually impaired and blind people; and
operative power source including preferably operable at single positive 9V DC power supply.

3. The electronic travel aid according to claim 2 wherein the disposition of the (a) said four ultrasonic sensors mounted on front side, two sensors on back side, one sensor on left side and one sensor on right side and (b) said safety indicating sensors comprising embedded ultrasonic sensor pairs including smoke/fire detection sensor, liquid detection sensor and metal detection sensor are selectively provided based on the height of the travel aid keeping in view the height/comfort of the visually impaired and blind person.

4. The electronic travel aid according to claim 1 comprising means for data collection and processing (DCPS) involving (i) DCPS vision section comprising a network of said ultrasonic sensor pairs adapted for object/obstacle detection from ground level to waist level height of the subject in front, left and right side including staircase detection, up stair and down stair application (ii) DCPS safety section comprising said network of smoke, liquid and metal detection sensors adapted to avoid life threatening injuries by conveying to the subject the presence of smoke, fire, gas, presence of liquid/water spillage on the floor and also the presence of metallic fencing, metallic casing, metallic floor and (iii) DCPS decision and control section comprising an 8-bit microcontroller adapted for processing real-time data collected by the sensors placed in said vision and safety sections thus enabling real-time navigation performed with scaled obstacle distance warning and effective usage of interrupts of adapted to invoke the stored pre-recorded speech messages based on the real-time detected and understood situations through repeated sampling of data before communicating a decision; and
means for speech/audio announcement section (SAS) including speech announcement which are operatively connected through wireless/wired modes with language flexibility for conveying detected conditions to the subject preferably involving audio recording and playback flash memory with capacity to store speech messages with desired duration with a specific control on the number of messages that may be increased by reducing the duration of each message also involving universal language to record speech warning messages to thereby invoke a relevant message from flash memory to be conveyed to the subject through a headphone/ear phone for the purpose of alerting the subject on the detected obstacle/situation.

5. The electronic travel aid according to wherein the wireless mode of connectivity is through half duplex wireless communication including a radio frequency modem preferably 2.4 GHz operated Radio Frequency (RF) modem and a baud rate 9600 bits per second (bps) communication and said wired mode of communication includes detachable connector between DCPS and SAS

6. The electronic travel aid according to claim 2 wherein front four sensors adapted for detection of ground level to waist level object/obstacle in front direction with the lower three ultrasonic sensors in front direction enable detection of up staircase, the Left and right sensors are adapted for detection of left and right side object/obstacle and two ultrasonic sensors are mounted on lower back-side are exclusively used for detection of down staircase.

7. The electronic travel aid according to claim 6 wherein the said lower three ultrasonic sensors in front direction enable detection of up staircase, an interrelated structured pattern of distance variation detected by these three sensors is involved for detection of staircase with repeated sampling of data for concluding staircase detection and subject can up stair and can understand the end of staircase with the help of stored speech messages and wherein the two ultrasonic sensors mounted on lower back-side of said cane are exclusively used for detection of down staircase and the subject can down stair and can understand the end of staircase with the help of stored speech messages.

8. The electronic travel aid according to claim 1 wherein said sensor means for the detection of staircase comprise first front lower sensor (s₁), second front lower sensor (s₂), third front lower sensor (s₃), Front upper sensor (s₄), first rear lower sensor (s₅), second rear lower sensor (s₆), left side sensor (s₇) and right side sensor (s₈) and said microcontroller and transceiver means is adapted to detect staircase based on said sensor inputs based on:
d(x) distance detected by a sensor (cm)
x tread depth (cm)
e error between theoretical and actual reading; and
riser height and tread depth
and generating therefrom:
(i) Average distance readings d(s₁), d(s₂), d(s₃), d(s₄) d(s₅) and d(s₆) obtained from sensor cycles ψ(i) and ψ(i+1)
(ii) Verifying:
d(s₄)≅d(s₃)+x+e (1)
d(s₃)≅d(s₂)+x+e (2)
d(s₂)≅d(s₁)+x+e (3)
(iii) Correlating between d(s₁), d(s₅) and d(s₆)
(iv) Computing distance values for x and error value e
(v) Computing a pattern based on detected distances values
(vi) If pattern indicates presence of up or down staircase, announcing it through speech message means and guiding the subject involving means preferably buzzer beep to proceed on the staircase.

9. The electronic travel aid according to claim 1 which is adapted to calculate dynamic distance of the object/obstacle from subject involving ultrasonic sensor and microcontroller means and also the floor status including dry, wet, metallic, non-metallic as well as generate safety indications on detection of smoke/fire.

10. The electronic travel aid according to claim 1 comprising two liquid detection sensors and one metal detection sensor wherein two probes of the first liquid detection sensor are mounted spaced apart on the bottom periphery of the said walking implement/cane and the said metal detection sensor is mounted inside at about 2 cm height from ground, two probes of the second liquid detection sensor are insulated and mounted above metal detection sensor such as to distinguish between metal and liquid based on the following:

| | | | | Discrimination |
|---|---|---|---|---|
| | Output of | | | of liquid |
| | first liquid | | | and metal |
| Sr. | detection | Output of metal | Output of second | based on sensor |
| No. | sensor | detection sensor | liquid detection sensor | outputs |
| 1 | NO | NO | NA* | None |
| 2 | NO | Yes | NA* | Metal |
| 3 | Yes | NO | NA* | Liquid |
| 4 | Yes | Yes | No | Metal |
| 5 | Yes | Yes | Yes | Both liquid and |
| | | | | metal |

11. The electronic travel aid according to claim 1 comprising non formal distance scaling involving gait analysis of visually challenged subjects and determining average step length (40 cm) while normal walking which is related to measure distance of obstacle in the front direction for non-formal distance scaling wherein full distance detection range in front direction is divided into integer multiples of said average step length (40 cm) and following:
$$\begin{matrix}m = \frac{d ( s )}{40} & ( 4 ) \\ p = d ( s ) mod 40 & ( 5 )\end{matrix}$$
Where,
d(s) detected obstacle distance
m no. of steps required to reach obstacle
p remainder
whereby based on values of m and p, generate required non-formal distance scaling.

12. The electronic travel aid according to claim 1 adapted for generating dynamic distance of the object/obstacle from subject involving said ultrasonic sensor and microcontroller and integrating non-formal distance scaling with speech messages with choice of full range non-formal distance scaled warning messages in terms of hand or step (Gait analysis based) distances preferably indicative of

| Distance (cm) | Speech message |
|---|---|
| Less than 60 | very close |
| 60 to 79 | two-step distance |
| 80 to 159 | four-steps distance |
| 160 to 239 | six-steps distance |
| 240 to 319 | eight-steps distance |

and/or

| Sr. | | Non-formal distance scaling |
|---|---|---|
| No. | Distance in centimeters | (with speech message) |
| 1 | Less than 70 cm | Object is very close |
| 2 | 70 cm to 79 cm | Object is at one-hand distance |
| 3 | 80 cm to 139 cm | Object is at two-hand distance |
| 4 | 140 cm to 209 cm | Object is at three-hand distance |
| 5 | 210 cm to 279 cm | Object is at four-hand distance |
| 6 | 280 cm to 349 cm | Object is at five-hand distance |
| 7 | 350 cm to 419 cm | Object is at six-hand distance |
| 8 | 420 cm to 500 cm | Object is at seven-hand distance |

13. The electronic travel aid as claimed in claim 1, wherein the microcontroller means adapted for way-finding with reduced information overload whereby in each sensor cycle (ψ), eight ultrasonic sensors are fired in consistent sequence to generate:
ψ=F(s₁,s₅,s₆)+wₜ+F(s₂,s₇,s₈)+wₜ+F(s₃,s₄,s₅)+wₜ (6)
where,
F(s₁,s₅,s₆) simultaneous firing of s₁, s₅ and s₆ ultrasonic sensors
wₜ waiting time (35 ms)
and wherein such two sensor cycles ψ(i) and ψ(i+1) for recording average distance values detected by individual sensor are involved and implemented with reduced information overload (WRIO), by generating a logical map of surrounding correlating sensor outputs and offer optimized need basis information to the subject with minimal occlusion of external acoustic signals such that when it infers the presence of the up or down staircase it is adapted to invoke the dedicated routine, where it adaptively fires respective sensors and performs dedicated processing of staircase related data to lead to a practical decision.

14. The electronic travel aid according to claim 1 wherein it maintains a safety margin distance for walking and adapted to avoid collision with possible obstacles in front, left and right direction preferably with variable frequency buzzer beeps for staircase navigation.

15. The electronic travel aid according to claim 13 adapted for maintaining said reduced information overload comprising:
(i) recording said output of sensor cycles ψ(i) and ψ(i+1)
ψ(i)=F(s₁,s₅,s₆)+wₜ+F(s₂,s₇,s₈)+wₜ+F(s₃,s₄,s₅)+wₜ
ψ(i+1)=F(s₁,s₅,s₆)+wₜ+F(s₂,s₇,s₈)+wₜ+F(s₃,s₄,s₅)+wₜ
(ii) comparing detected situations, calculated obstacles distances and their approximate directions;
(iii) construct a logical map of surrounding correlating sensor outputs;
(iv) estimate safety distance margins from possible obstacles in constructed surrounding map;
(v) prioritize received surrounding information; and
(vi) choose desired cue from available options of communication medium (speech messages and variable frequency buzzer beeps) to convey optimum information to the subject including (a) Interrupts: staircase navigation and safety indicators are implemented with variable frequency buzzer beeps and external interrupts respectively and (b) generation of optimum information and cues for relevant surrounding environment.

16. (canceled)
